(19) United States
(12) Patent Application Publication
(10) Pub. No.: US 2025/0182297 A1
(43) Pub. Date: Jun. 5, 2025

(54) Systems and Methods for Pathological Image Segmentation via Molecular-Empowered Learning

(71) Applicant: Vanderbilt University, Nashville, TN (US)

(72) Inventors: Yuankai Huo, Nashville, TN (US); Haichun Yang, Nashville, TN (US); Ruining Deng, Nashville, TN (US)

(21) Appl. No.: 18/967,022

(22) Filed: Dec. 3, 2024

Related U.S. Application Data
(60) Provisional application No. 63/606,252, filed on Dec. 5, 2023.

(51) Int. Cl. G06T 7/174; G06T 7/30

(52) U.S. Cl. CPC G06T 7/174; G06T 7/30; G06T 2207/10056; G06T 2207/20084

(57) ABSTRACT

Disclosed herein is a method for producing training data using a machine learning model trained with noisy annotated training data. The method includes receiving a plurality of anatomical images and corresponding molecular images, wherein each of a plurality of pairs of corresponding anatomical and molecular images captures a respective biological specimen. The method includes receiving at least one annotation on an anatomical image that is informed by its corresponding molecular image, wherein the at least one annotation identifies a functional unit of interest within the anatomical image. The method includes training a machine learning model using said annotated images, wherein the trained machine learning model is configured for multi-class functional unit segmentation.

### STATEMENT OF GOVERNMENT SUPPORT

This invention was made with government support under Grant nos. DK135597 and DK056942 awarded by the National Institutes of Health and Grant no. HT9425-23-1-0003 awarded by the Department of Defense.

### BACKGROUND

Multi-class cell segmentation is an essential technique for analyzing tissue samples in digital pathology. Accurate cell quantification assists pathologists in identifying and diagnosing diseases [5, 29] as well as obtaining detailed information about the progression of the disease [23], its severity [28], and the effectiveness of treatment [15]. For example, the morphology and density of podocyte and mesangial cells in the glomerulus offer a signal of glomerular injury in renal pathology [14]. The cell-level characterization is challenging for experienced pathologists due to the decades of expensive medical training, long annotation time, large variability [30], and low accuracy, while it is impractical to hire a massive number of experienced pathologists for cell annotation.

Previous works proposed several computer vision tools to perform automated or semi-automated cell segmentation on pathological images [17], including AnnotatorJ [12], NuClick [16], QuPath [2], etc. Such software is able to mark nuclei, cells, and multi-cellular structures by compiling pre-trained segmentation models [11], color deconvolution [25], or statistical analysis [22]. However, those automatic approaches still heavily rely on the morphology of cells from pathological Periodic acid-Schiff (PAS) images, thus demanding intensive human intervention for extra supervision and correction. Recently, immunofluorescence (IF) staining imaging has been widely used to visualize multiple biomolecules simultaneously in a single sample using fluorescently labeled antibodies [6, 20]. Such technology can accurately serve as a guide to studying the heterogeneity of cellular populations, providing reliable information for cell annotation. Furthermore, crowd-sourcing technologies [1, 13, 19] were introduced to generate better annotation for AI learning from multiple annotations.

### SUMMARY

A molecular-empowered learning method is disclosed herein that democratizes Artificial Intelligence (AI) pathological image segmentation by employing only lay annotators. The learning pipeline consists of (1) morphology-molecular multi-modality image registration, (2) molecular-informed layman annotation, and (3) molecular-oriented corrective learning. The pipeline alleviates the difficulties at the research and development stage from the expert level (e.g., experienced pathologists) while relegating annotation to the lay annotator level (e.g., non-expert annotators), all while enhancing both the accuracy and efficiency of the cell-level annotations. An efficient semi-supervised learning strategy is disclosed to offset the impact of noisy label learning on lay annotations.

The molecular-empowered learning scheme for multi-class cell segmentation using partial labels from lay annotators integrates (1) Giga-pixel level molecular morphology cross-modality registration, (2) molecular-informed annotation, and (3) molecular-oriented segmentation model to achieve a statistically significant increase of performance via lay annotators as compared with experienced pathologists. A deep corrective learning method is disclosed to further maximize the cell segmentation accuracy using partially annotated noisy annotation from lay annotators.

In some aspects, described herein is a method, the method including: receiving a plurality of anatomical images; receiving a plurality of corresponding molecular images, wherein each of a plurality of pairs of corresponding anatomical and molecular images captures a respective biological specimen; registering each of the plurality of pairs of corresponding anatomical and molecular images; for each of the plurality of pairs of corresponding anatomical and molecular images, receiving at least one annotation on an anatomical image that is registered to its corresponding molecular image, wherein the at least one annotation identifies a functional unit of interest within the anatomical image; and creating a dataset including a plurality of annotated anatomical images, wherein the dataset is used to train a machine learning model, wherein the machine learning model is configured for multi-class functional unit segmentation.

In some aspects, the method further includes annotating, by a layperson, the plurality of anatomical images using the plurality of corresponding molecular images as a guide.

In some aspects, the method further includes evaluating the at least one annotation using a corrective machine learning model.

In some aspects, evaluating the at least one annotation using the corrective machine learning model includes: providing an unannotated anatomical image into the corrective machine learning model; receiving, from the corrective machine learning model, a corrected annotated anatomical image; and comparing the anatomical image including the at least one annotation to the corrected annotated anatomical image.

In some aspects, the method further includes adjusting the at least one annotation on the anatomical image based on a comparison of the anatomical image including the at least one annotation to the corrected annotated anatomical image.

In some aspects, the method further includes training the corrective machine learning model using a second dataset including a plurality of expertly-annotated anatomical images.

In some aspects, the plurality of anatomical images are histological stained

images.

In some aspects, the plurality of corresponding molecular images are immunofluorescence (IF) images.

In some aspects, the machine learning model is a deep learning model.

In some aspects, the machine learning model is a convolutional neural network.

In some aspects, described herein is a system, the system including: a processor; and a memory operably coupled to the processor, the memory having computer-executable instructions stored thereon that, when executed by the processor, cause the processor to: receive a plurality of anatomical images; receive a plurality of corresponding molecular images, wherein each of a plurality of pairs of corresponding anatomical and molecular images captures a respective biological specimen; register each of the plurality of pairs of corresponding anatomical and molecular images; for each of the plurality of pairs of corresponding anatomical and molecular images, receive at least one annotation on an anatomical image that is informed by its corresponding molecular image, wherein the at least one annotation identifies a functional unit of interest within the anatomical image; and create a dataset including a plurality of annotated anatomical images, wherein the dataset is used to train a machine learning model, wherein the machine learning model is configured for multi-class functional unit segmentation.

In some aspects, the memory further includes computer-executable instructions that, when executed by the processor, cause the processor to: receive at least one annotation, by a layperson, on an anatomical image using the plurality of corresponding molecular images as a guide.

In some aspects, the memory further includes computer-executable instructions that, when executed by the processor, cause the processor to: evaluate the at least one annotation using a corrective machine learning model.

In some aspects, evaluate the at least one annotation using the second machine learning model includes: providing an unannotated anatomical image into the corrective machine learning model; receiving, from the corrective machine learning model, a corrected annotated anatomical image; and comparing the anatomical image including the at least one annotation to the corrected annotated anatomical image.

In some aspects, evaluate the at least one annotation using the corrective machine learning model further includes: adjusting the at least one annotation on the anatomical image based on a comparison of the anatomical image including the at least one annotation to the corrected annotated anatomical image.

In some aspects, evaluate the at least one annotation using the corrective machine learning model further includes: training the corrective machine learning model using a second dataset including a plurality of expertly-annotated anatomical images.

In some aspects, described herein is a method, the method including: deploying a trained machine learning model; receiving an anatomical image; inputting the anatomical image into the trained deployed machine learning model; and segmenting, using the trained deployed machine learning model, a subvisual or supervisual morphological feature in the anatomical image.

### BRIEF DESCRIPTION OF DRAWINGS

The skilled person in the art will understand that the drawings described below are for illustration purposes only.

FIG. 1 shows a comparison of a standard annotation process, an embodiment of the method, and expert annotation process.

FIGS. 2A-2E show schematics of an embodiment of the method of molecular empowered learning including an overview of the method (FIG. 2A); a first step morphology-molecular multi-modality image registration (FIG. 2B), a second step molecular-informed lay annotation (FIG. 2C), and a third step molecular-oriented corrective learning (FIG. 2D). FIG. 2E shows a flow chart of an embodiment of the method of molecular empowered learning.

FIG. 3 shows the molecular-oriented corrective learning in partial label model.

FIG. 4 shows examples of annotation accuracy using different annotation processes.

FIG. 5 shows a comparison of annotation accuracy between two expert annotators and three lay-annotators.

FIG. 6 shows an example computing device.

### DETAILED SPECIFICATION

To facilitate an understanding of the principles and features of various embodiments of the present invention, they are explained hereinafter with reference to their implementation in illustrative embodiments.

Image processing methods including artificial intelligence, machine learning, and image segmentations and classification algorithms provide unprecedentedly efficient methods to scale and speed up medical image diagnostics. It has become one of the most important methods in many image analysis areas, including medical diagnostics and research, which not only scales human-resources intensive diagnostic methods, but also drastically increases the availability and accessibility of such diagnostic methods. In the Examples below, the strength and abilities of the systems and methods described herein in image segmentations and classification to support medical image diagnostics, are shown.

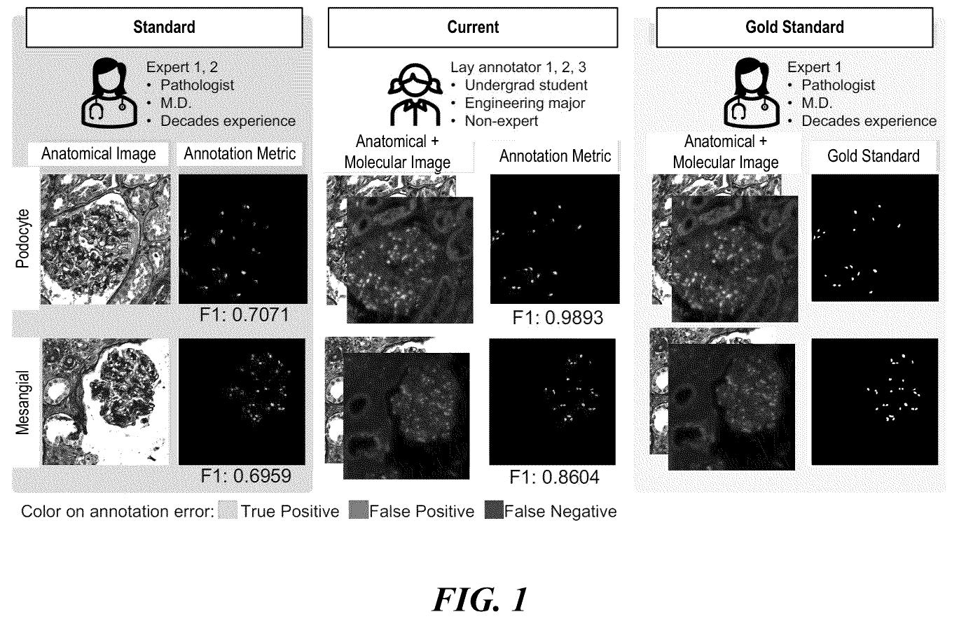

Multi-class cell segmentation in high-resolution Giga-pixel whole slide images (WSI) is critical for various clinical applications. Training an AI model typically requires labor-intensive pixel-wise manual annotation from experienced domain experts (e.g., pathologists). Moreover, such annotation is error-prone when differentiating fine-grained cell types (e.g., podocyte and mesangial cells) via the naked human eye. The methods and systems described herein related to (1) a molecular-empowered learning scheme for multi-class cell segmentation using partial labels from lay annotators; (2) integrating Giga-pixel level molecular morphology cross-modality registration, molecular-informed annotation, and molecular-oriented segmentation model, so as to achieve significantly superior performance via three lay annotators as compared with two experienced pathologists; and (3) providing a deep corrective learning (learning with imperfect label) method to further improve the segmentation performance using partially annotated, noisy data. The method democratizes the development of a pathological segmentation deep learning model to the lay annotator level, which consequently scales up the learning process similar to a non-medical computer vision task. A holistic molecular-empowered learning method is disclosed herein that democratizes Artificial Intelligence (AI) pathological image segmentation by employing lay annotators (per FIG. 1), and in some implementations employing only lay annotators.

As shown in FIG. 1, the left panel shows the standard annotation process (PAS only) for developing pathological segmentation models. The middle panel shows our molecular informed annotation (with both PAS and IF images) that allows for better annotation quality from lay annotators as compared with the left panel. The right panel presents the gold standard annotation for this study, where the annotations are obtained by experienced pathologists upon both PAS and IF images.

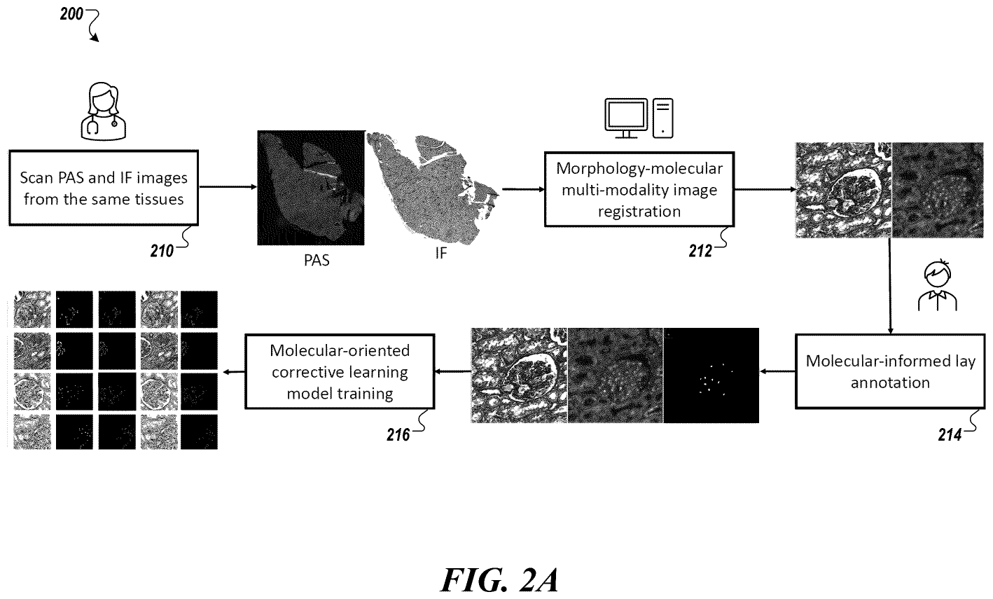

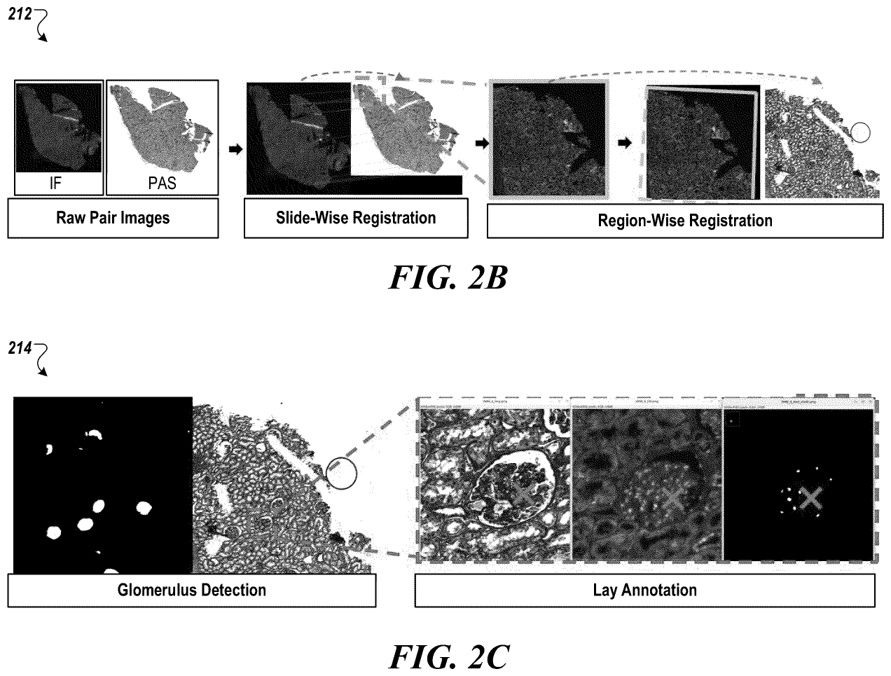

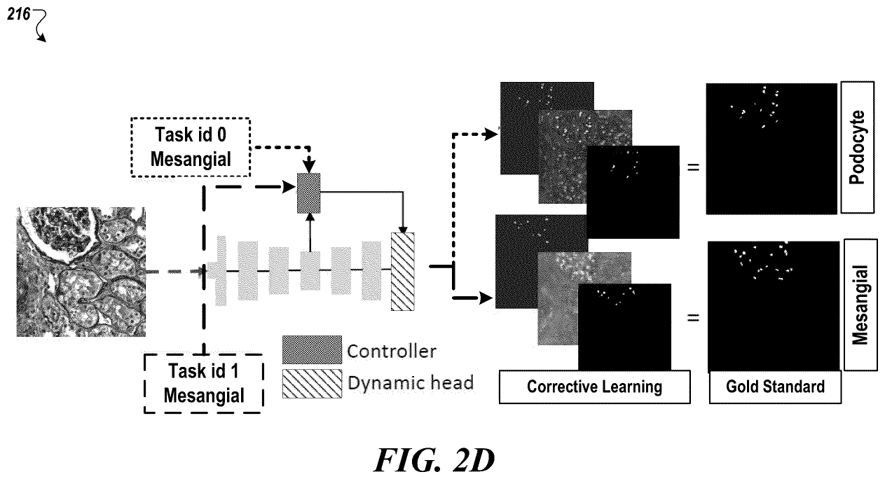

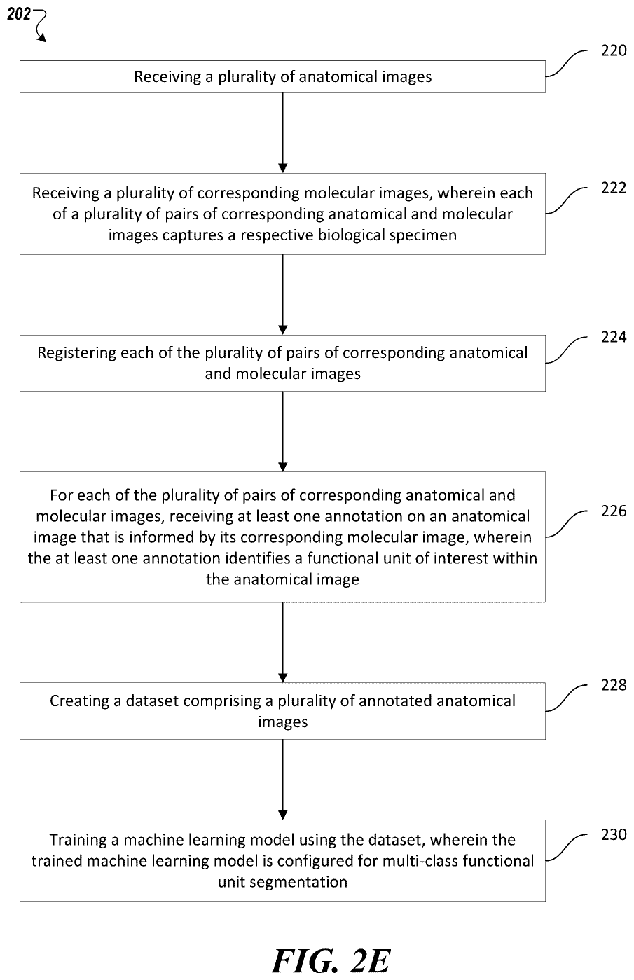

The learning pipeline, as shown in FIG. 2A includes steps of (212) morphology-molecular multi-modality image registration, (214) molecular-informed layman annotation, and (216) molecular-oriented corrective learning. The pipeline alleviates the difficulties at the research and development stage from the expert level (e.g., experienced pathologists) while relegating annotation to the lay annotator level (e.g., non-expert annotators), all while enhancing both the accuracy and efficiency of the cell-level annotations. An efficient semi-supervised learning strategy is proposed to offset the impact of noisy label learning on lay annotations.

In one embodiment, the method 200 includes receiving PAS and IF scan images from the same tissue 210, registering morphology-molecular multi-modality images 212, receiving molecular-informed annotation by a lay annotator 214, and employing molecular-oriented corrective learning model training 216. In some embodiments as shown in FIG. 2B, registering morphology-molecular multi-modality images 212 includes slide-wise registration and region-wise registration. In some embodiments as shown in FIG. 2C, receiving molecular-informed annotation by a lay annotator 214 includes glomerulus detection. In some embodiments as shown in FIG. 2D, employing molecular-oriented corrective learning model training 216 includes comparing the molecular-informed lay annotations and gold standard annotations.

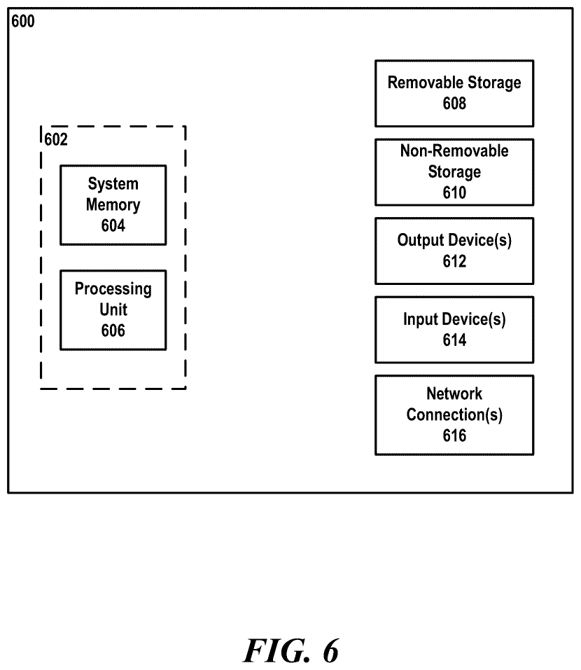

Another embodiment of the method for molecular empowered learning is shown in FIG. 2E. This disclosure contemplates that the operations of FIG. 2E can be performed using a computing device such as the computing device described with respect to FIG. 6, for example.

At step 220, the method includes receiving a plurality of anatomical images. In some embodiments, the plurality of anatomical images are histological stained images. For example, the histological stained images may be hematoxylin and cosin (H&E), periodic acid-schiff (PAS), Masson's trichrome, and Jones methenamine silver (JMS) stained images. It should be understood that H&E, PAS, Masson's trichrome, and JMS stained images are provided only as examples. This disclosure contemplates that other histological stained images may be received at step 220.

At step 222, the method includes receiving a plurality of corresponding molecular images, wherein each of a plurality of pairs of corresponding anatomical and molecular images captures a respective biological specimen. In some embodiments, the plurality of corresponding molecular images are immunofluorescence (IF) images. It should be understood that IF images are provided only as examples. This disclosure contemplates that other molecular images may be received at step 222.

At step 224, the method includes registering each of the plurality of pairs of corresponding anatomical and molecular images. Example image registration is shown in Step 1. As a non-limiting example described herein, a slide-wise multi-modality registration pipeline (Map3D) [8] can be employed to register the molecular images to anatomical images. It should be understood that Map3D is provided only as an example. This disclosure contemplates using another image registration technique at step 224.

At step 226, the method includes for each of the plurality of pairs of corresponding anatomical and molecular images, receiving at least one annotation on an anatomical image that is informed by its corresponding molecular image. As described in the examples below, the plurality of anatomical images can be annotated by a layperson using the plurality of corresponding molecular images as a guide. As used herein, a “layperson” refers to an individual who does not have specialized or professional knowledge, training, expertise, etc. in pathology. It should be understood that a layperson is in contrast to an expert, i.e., a person having specialized or professional knowledge, training, expertise, etc. in pathology. Example molecular-informed annotation is shown in Step 2 (FIG. 2B). Additionally, the at least one annotation identifies a functional unit of interest within the anatomical image. For example, the functional unit of interest may be Glomerulus, tubule, and/or vessel. In particular, the functional unit of interest may be proximal tubule or distal tubule. It should be understood that glomeruli, tubule, and/or vessels are provided only as examples. This disclosure contemplates annotating other functional units of interest.

At step 228, the method includes creating a dataset comprising a plurality of annotated anatomical images.

At step 230, the method includes training a machine learning model using the dataset. The trained machine learning model (i.e., the model that will be deployed) is configured for multi-class functional unit segmentation. In some embodiments, the machine learning model is an artificial neural network. In some embodiments, the machine learning model is a deep learning model. In other embodiments, the machine learning model is a convolutional neural network.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model.

A convolutional neural network (CNN) is a type of deep neural network that has been applied, for example, to image analysis applications. Unlike a traditional neural network, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks.

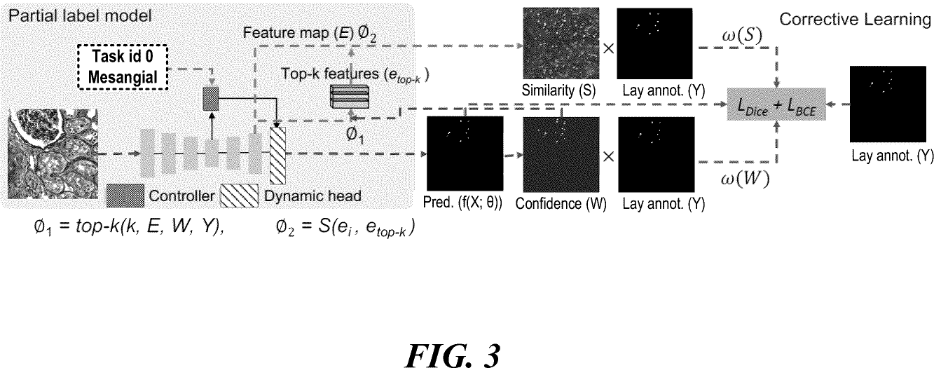

In some embodiments, the method optionally further includes evaluating the at least one annotation using a second machine learning model. In this embodiment, evaluating the at least one annotation using the second machine learning model includes: inputting an unannotated anatomical image into the second machine learning model; receiving from the second machine learning model a corrected annotated anatomical image; and comparing the anatomical image including the at least one annotation to the corrected annotated anatomical image. The method may further include adjusting the at least one annotation on the anatomical image based on the comparison of the anatomical image including the at least one annotation to the corrected annotated anatomical image. An example molecular-oriented corrective learning strategy is described with regard to FIG. 3 below.

In some embodiments, the method further includes training the second machine learning model using a second dataset including a plurality of expertly annotated anatomical images. It should be understood that images in the second dataset are annotated by an expert as opposed to a layperson as described herein.

In some embodiments, the trained machine learning models are used in a method, the method including: deploying a machine learning model; receiving an anatomical image; inputting the anatomical image into the deployed machine learning model; and segmenting, using the deployed machine learning model, a subvisual or supervisual morphological feature in the anatomical image.

An overview of the method including the entire labeling and auto-quantification pipeline is presented in FIGS. 2A-2D. Molecular images are aligned with anatomical images in order to provide accurate guidance for cell labeling by using multi-scale registration. After this registration, a functional unit segmentation model is implemented to localize the regions of glomeruli. Within those glomeruli, lay annotators label multiple cell types by using the pair-wise molecular images and anatomical images in ImageJ [12]. A partial-label learning model with a molecular-oriented corrective learning strategy is employed so as to diminish the gap between labels from lay annotators and gold standard labels.

Morphology-molecular multi-modality registration. Multi-modality, multi-scale registration is deployed to ensure the pixel-to-pixel correspondence (alignment) between molecular IF and PAS images at both the WSI and regional levels. To maintain the morphological characteristics of the functional unit structure, a slide-wise multi-modality registration pipeline (Map3D) [8] is employed to register the molecular images to anatomical images. The first stage is global alignment. The Map3D approach was employed to achieve reliable translation on WSIs when encountering missing tissues and staining variations. The output of this stage is a pair-wise affine matrix M_{Map3D}(t) from Eq. (1)

$${M}_{Map 3 D} = arg min {\sum }_{i = 1}^{N} {‖ A ( {x}_{i}^{IF} , M ) - {x}_{i}^{PAS} ‖}_{AffMap 3 D} \qquad ( 1 )$$

To achieve a more precise pixel-level correspondence, Autograd Image Registration Laboratory (AIRLab) [27] was utilized to calibrate the registration performance at the second stage. The output of this step is M_{AIRLab}(t) from Eq. 2.

$${M}_{AirLab} = arg min {A}_{{M}_{Map 3 D}} {\sum }_{i = 1}^{N} {‖ A ( {x}_{i}^{IF} , M ) - {x}_{i}^{PAS} ‖}_{AffAIRLab} \qquad ( 2 )$$

where i is the index of pixel xi in the image I, with N pixels. The two-stage registration (Map3D+AIRLab) affine matrix for each pair is presented in Eq. (3).

$$M = ( {M}_{Map 3 D} , {M}_{AIRLab} ) \qquad ( 3 )$$

In Eq. (1) and (2), A indicates the affine registration. The affine matrix M_{Map3D}(t) from Map3D is applied to obtain pair-wise image regions. The ∥.∥ Aff_{Map3D} and ∥.∥ Aff_{AIRLab} in Eq. (1) and (2) indicate the different similarity metrics for two affine registrations, respectively.

Molecular-informed annotation. After aligning molecular images with PAS images, an automatic multi-class functional unit segmentation pipeline Omni-Seg [7] is deployed to locate the tuft unit on the images. With the tuft masks, the molecular images then manifest heterogeneous cells with different color signals on pathological images during the molecular-informed annotation. Each anatomical image attains a binary mask for each cell type, in the form of a partial label. Following the same process, the pathologist examines both anatomical images and molecular images to generate a gold standard for this study (per FIG. 1).

Molecular-oriented corrective learning for partial label segmentation. The lack of molecular expertise as well as the variability in the quality of staining in molecular images can cause annotations provided by non-specialists to be unreliable and error-prone. Therefore, a corrective learning strategy (per FIG. 3) is used to efficiently train the model with noisy labels, so as to achieve the comparable performance of training the same model using the gold standard annotations.

Inspired by confidence learning [21] and similarity attention [18], top-k pixel feature embeddings at the annotation regions with higher confidences from the prediction probability (W, defined as confidence score in Eq. (4)) are selected as critical representations for the current cell type from the decoder (in Eq. (5)).

$$W = f ( X ; θ ) [ : , 1 ] \qquad ( 4 )$$

$$top - k ( k , E , W , Y ) = ( {e}_{1} , {e}_{1} ) , ( {e}_{2} , {e}_{2} ) , ... , ( {e}_{k} , {e}_{k} ) ⋂ Y ∈ ( E , W ) \qquad ( 5 )$$

where k denotes the number of selected embedding features. E is the embedding map from the last layer of the decoder, while Y is the lay annotation.

A cosine similarity score S is implemented between the embedding from an arbitrary pixel to those from critical embedding features as Eq. (6).

$$S ( {e}_{i} , {e}_{top - k} ) = \frac{{\sum }_{m = 1}^{M} ( {e}_{i} \times {e}_{top - k} )}{\sqrt{{\sum }_{m = 1}^{M} {{e}_{i}}^{2}} \times \sqrt{{\sum }_{m = 1}^{M} {( {e}_{top - k} )}^{2}}} \qquad ( 6 )$$

where m denotes the channel of the feature embeddings.

Since the labels from lay annotators might be noisy and erroneous, the W and S are applied in following Eq. (7) to highlight the regions where both the model and lay annotation agree on the current cell type, when calculating the loss function in Eq. (8).

$$ω ( W ) = exp ( W ) \times Y , ω ( S ) = S \times Y \qquad ( 7 )$$

$$ℒ ( Y , f ( X ; θ ) ) = ( {ℒ}_{Dice} ( Y , f ( X ; θ ) ) + {ℒ}_{BCE} ( Y , f ( X ; θ ) ) ) \times ω ( W ) \times ω ( S ) \qquad ( 8 )$$

### Example

Data. 11 PAS staining WSIs, including three slides with glomerular injury, were collected with pairwise IF images for the process. The stained tissues were scanned at a 20× magnification. After multi-modality multi-scale registration, 1,147 patches for podocyte cells, and 789 patches for mesangial cells were generated and annotated. Each patch has 512×512 pixels.

Morphology-molecular multi-modality registration. The slide-level global translation from Map3D was deployed at a 5× magnification, which is 2 μm per pixel. The 4096×4096 pixels PAS image regions with 1024 pixels overlapping were tiled on anatomical WSIs at a 20× magnification, which is 0.5 μm per pixel.

Molecular-empowered annotation. The automatic tuft segmentation and molecular knowledge images assisted the lay annotators with identifying glomeruli and cells. ImageJ (version v1.53t) was used throughout the entire annotation process. “Synchronize Windows” was used to display cursors across the modalities with spatial correlations for annotation. “ROI Manager” was used to store all of the cell binary masks for each cell type.

Molecular-oriented corrective learning. Patches were randomly split into training, validation, and testing sets with a ratio of 6:1:3, respectively, at the WSI level. The distribution of injured glomeruli and normal glomeruli were balanced in the split.

Experimental setting. Two experienced pathologists and three lay annotators without any specialized knowledge were included in the experiment. All anatomical and molecular patches of glomerular structures were extracted from WSI on a workstation equipped with a 12-core Intel Xeon W-2265 Processor, and NVIDIA RTXA6000 GPU. An 8-core AMD Ryzen 7 5800X Processor workstation with XP-PEN Artist 15.6 Pro Wacom is used for drawing the contour of each cell. Annotating one cell type on one WSI requires nine hours, while staining and scanning 24 IF WSIs (as a batch) requires three hours. The experimental setup for the two experts and the three lay annotators was kept strictly the same to ensure a fair comparison.

Evaluation metrics. 100 patches from the testing set with a balanced number of injuries and normal glomeruli were captured by the pathologists for evaluating morphology-based annotation and molecular-informed annotation. The annotation from one pathologist (over 20 years' experience) with both anatomical and molecular images as gold standard (per FIG. 1, right panel). The balanced F-score (F1) was used as the major metric for this study. The Fleiss' kappa was used to compute the inter-rater variability between experts and lay annotators.

### Results

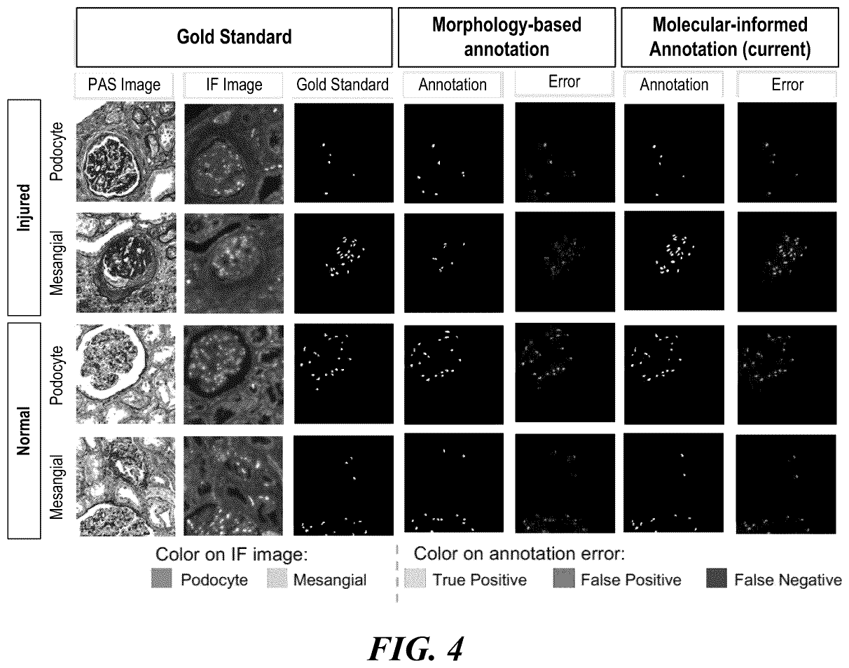

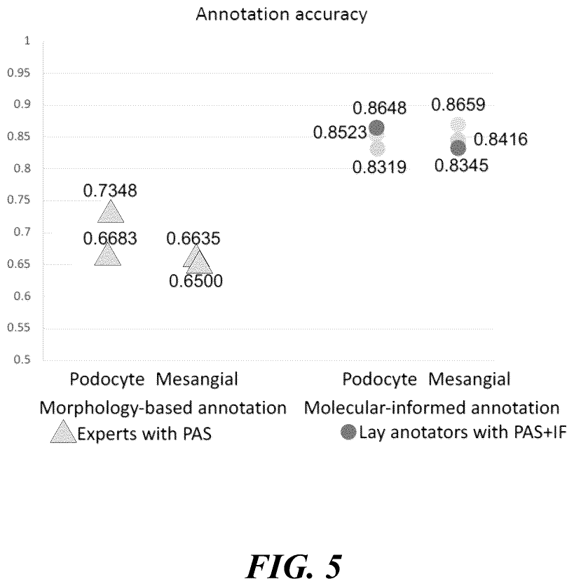

FIG. 4, FIG. 5, and Table 1 indicate the annotation performance from the naked human eye with expert knowledge and the lay annotator with molecular-informed learning. As shown, our learning method achieved better annotation with higher F1 scores with fewer false positive and false negative regions as compared with the pathologist's annotations. Statistically, the Fleiss' kappa test shows that the molecular-informed annotation by lay-annotators has higher annotation agreements than the morphology-based annotation by experts. This demonstrates the benefits of reducing the expertise requirement to a layman's level and improving accuracy in pathological cell annotation.

TABLE 1
Annotation accuracy from only anatomical morphology and
molecular-informed annotation. Average F1 scores and Fleiss'
kappa between two experts and three lay annotators.

| | Injured glomeruli | | Normal glomeruli | |
|---|---|---|---|---|
| Method | Podocyte | Mesangial | Podocyte | Mesangial |
| Morphology-based | 0.6964 | 0.6941 | 0.7067 | 0.6567 |
| annotation (2 | | | | |
| pathologist | | | | |
| with PAS) | | | | |
| Molecular-informed | 0.8374 | 0.8434 | 0.8619 | 0.8511 |
| annotation (3 lay | | | | |
| annotators with | | | | |
| PAS + IF) | | | | |
| p-value | p < 0.001 | p < 0.001 | p < 0.001 | p < 0.001 |
| | Average | | Fleiss' kappa | |
| Method | Podocyte | Mesangial | Podocyte | Mesangial |
| Morphology-based | 0.7015 | 0.6567 | 0.3973 | 0.4161 |
| annotation (2 | | | | |
| pathologist | | | | |
| with PAS) | | | | |
| Molecular-informed | 0.8496 | 0.8473 | 0.6406 | 0.5978 |
| annotation (3 lay | | | | |
| annotators with | | | | |
| PAS + IF) | | | | |
| p-value | p < 0.001 | p < 0.001 | N/A | N/A |

Performance on multi-class cell segmentation. In Table.2, the proposed partial label segmentation method was compared to baseline models, including (1) multiple individual models (U-Nets [24], DeepLabv3s [4], and Residual U-Nets [26]), (2) multi-head models (Multi-class [10], Multi-Kidney [3]), and (3) single dynamic networks with noisy label learning (Omni-Seg [7]). The results showed that the partial label paradigm shows superior performance on multi-class cell segmentation. The exemplary model particularly demonstrates better quantification in the normal glomeruli, which contain large amounts of cells.

To evaluate the performance of molecular-oriented corrective learning on imperfect lay annotation, two noisy label learning strategies were implemented, Confidence Learning (CL) [21] and Partial Label Loss (PLL) [18] with the proposed Molecular-oriented corrective learning (MOCL) on the exemplary partial label model. As a result, the exemplary molecular-oriented corrective learning alleviated the error between lay annotation and the gold standard in the learning stage, especially in the injured glomeruli that incorporate more blunders in the annotation due to the identification difficulty from morphology changing.

Ablation study. The purpose of corrective learning was to alleviate the noise and distillate the correct information, so as to improve the model performance using lay

TABLE 2
Performance of deep learning based multi-class cell segmentation.

| | | Injured glomeruli | | Normal glomeruli | | Average | |
|---|---|---|---|---|---|---|---|
| Method | Data | Podocyte | Mesangial | Podocyte | Mesangial | Podocyte | Mesangial |
| U-Nets[24] | G.S. | 0.6719 | 0.6867 | 0.7203 | 0.6229 | 0.6944 | 0.6617 |
| DeepLabV3s [4] | G.S. | 0.7127 | 0.6680 | 0.7395 | 0.6163 | 0.7251 | 0.6476 |
| Residual | G.S. | 0.6968 | 0.6913 | 0.7481 | 0.6601 | 0.7207 | 0.6790 |
| U-Nets[26] | | | | | | | |
| Multi-class [10] | G.S. | 0.5201 | 0.4984 | 0.4992 | 0.4993 | 0.5214 | 0.4987 |
| Multi-kidney [3] | G.S. | 0.6735 | 0.6734 | 0.7542 | 0.6581 | 0.7108 | 0.6691 |
| Omni-Seg [7] | G.S. | 0.7115 | 0.6970 | 0.7746 | 0.6895 | 0.7407 | 0.6940 |
| Omni-seg [7] | L.A. | 0.6941 | 0.7083 | 0.7703 | 0.6822 | 0.7295 | 0.6980 |
| CL [21] | L.A. | 0.7047 | 0.6961 | 0.7536 | 0.6754 | 0.7274 | 0.6879 |
| PLL [9] | L.A. | 0.6276 | 0.6853 | 0.6825 | 0.6268 | 0.6531 | 0.6622 |
| MOCL (current) | L.A. | 0.7198 | 0.7157 | 0.7657 | 0.6830 | 0.7411 | 0.7028 |

annotation. Four designs of corrective learning with different utilization of similarity losses and confidence losses were evaluated with lay annotation in Table. 3. Each score was used in either an exponential function or a linear function (Eq. (7)), when multiplying and calculating the loss function (Eq. (8)). The bold configuration was selected as the final design.

TABLE 3
Ablation study on different molecular-
oriented corrective learning designs.

| Confidence | Similarity | Podocyte | Masengial | Average |
|---|---|---|---|---|
| Score | Score | F1 | F1 | F1 |
| Linear | Linear | 0.7255 | 0.6843 | 0.7049 |
| Linear | Exponent | 0.7300 | 0.6987 | 0.7144 |
| Exponent | Linear | 0.7411 | 0.7028 | 0.7219 |
| Exponent | Exponent | 0.7304 | 0.6911 | 0.7108 |

Conclusion. In this work, a holistic, molecular-empowered learning solution to alleviate the difficulties of developing a multi-class cell segmentation deep learning model from the expert level to the lay annotator level was studied, enhancing the accuracy and efficiency of cell-level annotation. An efficient corrective learning strategy was proposed to offset the impact of noisy label learning from lay annotation. The results demonstrate the feasibility of democratizing the deployment of a pathology AI model while only relying on lay annotators.

### Example Computing Device

It should be appreciated that the logical operations described herein with respect to the various figures may be implemented (1) as a sequence of computer implemented acts or program modules (i.e., software) running on a computing device (e.g., the computing device described in FIG. 6), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 6, an example computing device 600 upon which the methods described herein may be implemented is illustrated. It should be understood that the example computing device 600 is only one example of a suitable computing environment upon which the methods described herein may be implemented. Optionally, the computing device 600 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 6 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes' classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP), convolutional neural network (CNN), and Transformers.

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

The following patents, applications, and publications as listed below and throughout this document are hereby incorporated by reference in their entirety herein.

### REFERENCES

1. Amgad, M., Atteya, L. A., Hussein, H., Mohammed, K. H., Hafiz, E., Elsebaie, M. A., Al-husseiny, A. M., AlMoslemany, M. A., Elmatboly, A. M., Pappalardo, P. A., et al.: Nucls: A scalable crowdsourcing approach and dataset for nucleus classification and segmentation in breast cancer. GigaScience 11 (2022)
2. Bankhead, P., Loughrey, M. B., Ferna'ndez, J. A., Dombrowski, Y., McArt, D. G., Dunne, P. D., McQuaid, S., Gray, R. T., Murray, L. J., Coleman, H. G., et al.: Qupath: Open source software for digital pathology image analysis. Scientific reports 7(1), 1-7 (2017)
3. Bouteldja, N., Klinkhammer, B. M., Bu″low, R. D., Droste, P., Otten, S. W., von Stillfried, S. F., Moellmann, J., Sheehan, S. M., Korstanje, R., Menzel, S., et al.: Deep learning-based segmentation and quantification in experimental kidney histopathology. Journal of the American Society of Nephrology 32(1), 52-68 (2021)
4. Chen, L. C., Papandreou, G., Schroff, F., Adam, H.: Rethinking atrous convolution for semantic image segmentation. arXiv preprint arXiv:1706.05587 (2017)
5. Comaniciu, D., Meer, P.: Cell image segmentation for diagnostic pathology. Advanced algorithmic approaches to medical image segmentation: State-of-the-art applications in cardiology, neurology, mammography and pathology pp. 541-558 (2002)
6. Day, K. E., Beck, L. N., Deep, N. L., Kovar, J., Zinn, K. R., Rosenthal, E. L.: Fluorescently labeled therapeutic antibodies for detection of microscopic melanoma. The Laryngoscope 123(11), 2681-2689 (2013)
7. Deng, R., Liu, Q., Cui, C., Asad, Z., Huo, Y., et al.: Single dynamic network for multi-label renal pathology image segmentation. In: International Conference on Medical Imaging with Deep Learning. pp. 304-314. PMLR (2022)
8. Deng, R., Yang, H., Jha, A., Lu, Y., Chu, P., Fogo, A.B., Huo, Y.: Map3d: Registration-based multi-object tracking on 3d serial whole slide images. IEEE transactions on medical imaging 40(7), 1924-1933 (2021)
9. Fan, J., Zhang, Z., Tan, T.: Pointly-supervised panoptic segmentation. In: Computer Vision-ECCV 2022: 17th European Conference, Tel Aviv, Israel, Oct. 23-27, 2022, Proceedings, Part XXX. pp. 319-336. Springer (2022)
10. Gonza'lez, G., Washko, G. R., San Jose' Este'par, R.: Multi-structure segmentation from partially labeled datasets. application to body composition measurements on ct scans. In: Image Analysis for Moving Organ, Breast, and Thoracic Images, pp. 215-224. Springer (2018)
11. Graham, S., Vu, Q. D., Raza, S. E. A., Azam, A., Tsang, Y. W., Kwak, J. T., Rajpoot, N.: Hovernet: Simultaneous segmentation and classification of nuclei in multi-tissue histology images. Medical Image Analysis 58, 101563 (2019)
12. Hollandi, R., Dio'sdi, A'., Hollandi, G., Moshkov, N., Horva'th, P.: Annotatorj: an imagej plugin to ease hand annotation of cellular compartments. Molecular biology of the cell 31(20), 2179-2186 (2020)
13. Hsueh, P. Y., Melville, P., Sindhwani, V.: Data quality from crowdsourcing: a study of annotation selection criteria. In: Proceedings of the NAACL HLT 2009 workshop on active learning for natural language processing. pp. 27-35 (2009)
14. Imig, J. D., Zhao, X., Elmarakby, A. A., Pavlov, T.: Interactions between podocytes, mesangial cells, and glomerular endothelial cells in glomerular diseases. Frontiers in Physiology p. 488 (2022)
15. Jime'nez-Heffernan, J., Bajo, M. A., Perna, C., del Peso, G., Larrubia, J. R., Gamallo, C., Sa'nchez-Tomero, J., Lo'pez-Cabrera, M., Selgas, R.: Mast cell quantification in normal peritoneum and during peritoneal dialysis treatment. Archives of pathology & laboratory medicine 130(8), 1188-1192 (2006)
16. Koohbanani, N. A., Jahanifar, M., Tajadin, N. Z., Rajpoot, N.: Nuclick: a deep learning framework for interactive segmentation of microscopic images. Medical Image Analysis 65, 101771 (2020)
17. Korzynska, A., Roszkowiak, L., Zak, J., Siemion, K.: A review of current systems for annotation of cell and tissue images in digital pathology. Biocybernetics and Biomedical Engi-neering 41(4), 1436-1453 (2021)
18. Li, B., Li, Y., Eliceiri, K. W.: Dual-stream multiple instance learning network for whole slide image classification with self-supervised contrastive learning. In: Proceedings of the IEEE/CVF conference on computer vision and pattern recognition. pp. 14318-14328 (2021)
19. Marzahl, C., Aubreville, M., Bertram, C. A., Gerlach, S., Maier, J., Voigt, J., Hill, J., Klopfleisch, R., Maier, A.: Is crowd-algorithm collaboration an advanced alternative to crowd-sourcing on cytology slides? In: Bildverarbeitung fur die Medizin 2020: Algorithmen-Systeme-Anwendungen. Proceedings des Workshops vom 15. bis 17. Marz 2020 in Berlin. pp. 26-31. Springer (2020)
20. Moore, L. S., Rosenthal, E. L., de Boer, E., Prince, A. C., Patel, N., Richman, J. M., Morlandt, A. B., Carroll, W. R., Zinn, K. R., Warram, J. M.: Effects of an unlabeled loading dose on tumor-specific uptake of a fluorescently labeled antibody for optical surgical navigation. Molecular Imaging and Biology 19, 610-616 (2017)
21. Northcutt, C., Jiang, L., Chuang, I.: Confident learning: Estimating uncertainty in dataset labels. Journal of Artificial Intelligence Research 70, 1373-1411 (2021)
22. Oberg, A. L., Mahoney, D. W.: Statistical methods for quantitative mass spectrometry proteomic experiments with labeling. BMC bioinformatics 13(16), 1-18 (2012)
23. Olindo, S., Lezin, A., Cabre, P., Merle, H., Saint-Vil, M., Kaptue, M.E., Signate, A., Cesaire, R., Smadja, D.: Htlv-1 proviral load in peripheral blood mononuclear cells quantified in 100 ham/tsp patients: a marker of disease progression. Journal of the neurological sciences 237(1-2), 53-59 (2005)
24. Ronneberger, O., Fischer, P., Brox, T.: U-net: Convolutional networks for biomedical image segmentation. In: Medical Image Computing and Computer-Assisted Intervention-MICCAI 2015: 18th International Conference, Munich, Germany, Oct. 5-9, 2015, Proceedings, Part III 18. pp. 234-241. Springer (2015)
25. Ruifrok, A. C., Johnston, D. A., et al.: Quantification of histochemical staining by color de-convolution. Analytical and quantitative cytology and histology 23(4), 291-299 (2001)
26. Salvi, M., Mogetta, A., Gambella, A., Molinaro, L., Barreca, A., Papotti, M., Molinari, F.: Automated assessment of glomerulosclerosis and tubular atrophy using deep learning. Computerized Medical Imaging and Graphics 90, 101930 (2021)
27. Sandkuhler, R., Jud, C., Andermatt, S., Cattin, P. C.: Airlab: autograd image registration laboratory. arXiv preprint arXiv:1806.09907 (2018)
28. Wijeratne, D. T., Fernando, S., Gomes, L., Jeewandara, C., Ginneliya, A., Samarasekara, S., Wijewickrama, A., Hardman, C. S., Ogg, G. S., Malavige, G. N.: Quantification of dengue virus specific t cell responses and correlation with viral load and clinical disease severity in acute dengue infection. PLoS neglected tropical diseases 12(10), e0006540 (2018)
29. Xing, F., Yang, L.: Robust nucleus/cell detection and segmentation in digital pathology and microscopy images: a comprehensive review. IEEE reviews in biomedical engineering 9, 234-263 (2016)
30. Zheng, Y., Cassol, C. A., Jung, S., Veerapaneni, D., Chitalia, V. C., Ren, K. Y., Bellur, S. S., Boor, P., Barisoni, L. M., Waikar, S. S., et al.: Deep-learning-driven quantification of interstitial fibrosis in digitized kidney biopsies. The American journal of pathology 191(8), 1442-1453 (2021)

What is claimed is:

1. A method comprising:
receiving a plurality of anatomical images;
receiving a plurality of corresponding molecular images, wherein each of a plurality of pairs of corresponding anatomical and molecular images captures a respective biological specimen;
registering each of the plurality of pairs of corresponding anatomical and molecular images;
for each of the plurality of pairs of corresponding anatomical and molecular images, receiving at least one annotation on an anatomical image that is registered to its corresponding molecular image, wherein the at least one annotation identifies a functional unit of interest within the anatomical image; and
creating a dataset comprising a plurality of annotated anatomical images, wherein the dataset is used to train a machine learning model, wherein the machine learning model is configured for multi-class functional unit segmentation.

2. The method of claim 1, further comprising annotating, by a layperson, the plurality of anatomical images using the plurality of corresponding molecular images as a guide.

3. The method of claim 1, further comprising evaluating the at least one annotation using a corrective machine learning model.

4. The method of claim 3, wherein evaluating the at least one annotation using the corrective machine learning model comprises:
providing an unannotated anatomical image into the corrective machine learning model;
receiving, from the corrective machine learning model, a corrected annotated anatomical image; and
comparing the anatomical image including the at least one annotation to the corrected annotated anatomical image.

5. The method of claim 4, further comprising adjusting the at least one annotation on the anatomical image based on a comparison of the anatomical image including the at least one annotation to the corrected annotated anatomical image.

6. The method of claim 4, further comprising training the corrective machine learning model using a second dataset comprising a plurality of expertly-annotated anatomical images.

7. The method of claim 1, wherein the plurality of anatomical images are histological stained images.

8. The method of claim 1, wherein the plurality of corresponding molecular images are immunofluorescence (IF) images.

9. The method of claim 1, wherein the machine learning model is a deep learning model.

10. The method of claim 1, wherein the machine learning model is a convolutional neural network.

11. A system comprising:
a processor; and
a memory operably coupled to the processor, the memory having computer-executable instructions stored thereon that, when executed by the processor, cause the processor to:
receive a plurality of anatomical images;
receive a plurality of corresponding molecular images, wherein each of a plurality of pairs of corresponding anatomical and molecular images captures a respective biological specimen;
register each of the plurality of pairs of corresponding anatomical and molecular images;
for each of the plurality of pairs of corresponding anatomical and molecular images, receive at least one annotation on an anatomical image that is informed by its corresponding molecular image, wherein the at least one annotation identifies a functional unit of interest within the anatomical image; and
create a dataset comprising a plurality of annotated anatomical images, wherein the dataset is used to train a machine learning model, wherein the machine learning model is configured for multi-class functional unit segmentation.

12. The system of claim 11, wherein the memory further comprises computer-executable instructions that, when executed by the processor, cause the processor to:
receive at least one annotation, by a layperson, on an anatomical image using the plurality of corresponding molecular images as a guide.

13. The system of claim 11, wherein the memory further comprises computer-executable instructions that, when executed by the processor, cause the processor to:
evaluate the at least one annotation using a corrective machine learning model.

14. The system of claim 13, wherein evaluate the at least one annotation using the second machine learning model comprises:
providing an unannotated anatomical image into the corrective machine learning model;
receiving, from the corrective machine learning model, a corrected annotated anatomical image; and
comparing the anatomical image including the at least one annotation to the corrected annotated anatomical image.

15. The system of claim 14, wherein evaluate the at least one annotation using the corrective machine learning model further comprises:
adjusting the at least one annotation on the anatomical image based on a comparison of the anatomical image including the at least one annotation to the corrected annotated anatomical image.

16. The system of claim 14, wherein evaluate the at least one annotation using the corrective machine learning model further comprises:
training the corrective machine learning model using a second dataset comprising a plurality of expertly-annotated anatomical images.

17. The system of claim 11, wherein the plurality of anatomical images are histological stained images.

18. The system of claim 11, herein the plurality of corresponding molecular images are immunofluorescence (IF) images.

19. The system of claim 11, wherein the machine learning model is a deep learning model or a convolutional neural network.

20. A method comprising:
deploying a trained machine learning model;
receiving an anatomical image;
inputting the anatomical image into the trained deployed machine learning model; and
segmenting, using the trained deployed machine learning model, a subvisual or supervisual morphological feature in the anatomical image.
